(19) United States
(12) Patent Application Publication
(10) Pub. No.: US 2020/0153469 A1
(43) Pub. Date: May 14, 2020

(54) ACCESSORY DEVICE

(71) Applicant: Samsung Electronics Co., Ltd., Suwon-si (KR)

(72) Inventor: Su Min Park, Changwon-si (KR)

(73) Assignee: Samsung Electronics Co., Ltd., Suwon-si, (KR)

(21) Appl. No.: 16/408,704

(22) Filed: May 10, 2019

(30) Foreign Application Priority Data
Nov. 12, 2018 (KR) 10-2018-0138117

(51) Int. Cl. H04B 1/18; G09G 3/20; H04W 12/06

(52) U.S. Cl. CPC H04B 1/18; G09G 2330/021; H04W 12/06; G09G 3/2092

(57) ABSTRACT

An accessory device including a first antenna configured to receive a first signal from an external device, a switch, a first switch configured to enable or disable an electrical connection between the first antenna and a controller may be provided. The controller may be configured to be electrically connected to the first antenna, receive the first signal via the first antenna, perform a rectification operation of the first signal, and control the first switch so that the first switch is turned on or turned off based on a second signal received from the external device.

This application claims priority to Korean Patent Application No. 10-2018-0138117, filed on Nov. 12, 2018, and all the benefits accruing therefrom under 35 U.S.C. § 119, the disclosure of which is incorporated herein by reference in its entirety.

### BACKGROUND

### 1. Field

The present inventive concepts relate to accessory devices equipped with a switch for controlling communication with an electronic device.

### 2. Description of the Related Art

Spread and use of various electronic devices are rapidly increasing by virtue of remarkable development of information communication technologies, semiconductor technologies and the like. Especially, recent electronic devices have been developed to communicate with each other, while being carried.

For example, electronic devices such as a smart phone, a personal computer, and a tablet provide several convenient functions for users via various applications. The electronic devices tend to transform into devices that may utilize various forms of information in addition to voice call functions through provision of various functions.

Recently, an accessory device connected to the electronic device to interlock with the electronic device or perform some functions for the electronic device has been developed and provided for use with the electronic device. For example, the accessory device may be various devices such as a protective cover for protecting the electronic device, a dock capable of mounting the electronic device, or a charging device capable of charging the electronic device.

In the case of an accessory device that needs to be supplied with power, in many cases, it is desired to autonomously generate power, and especially in the case of a cover accessory of an electronic device, power is generated via an NFC RF Field of the electronic device. In this case, when the electronic device tries to communicate with another electronic device other than the accessory device, interference occurs due to an antenna of the accessory device. Thus, communication with another electronic device frequently fails. Therefore, a scheme for suppressing such issues are desired.

### SUMMARY

Some example embodiments of the present inventive concepts provide accessory devices that are capable of reducing interference caused by an antenna thereof, by adjusting a mode in which an antenna for wireless communication with an external device is enabled.

Some example embodiments of the present inventive concepts provide accessory devices capable of reducing or minimizing power consumption thereof and electronic devices by adjusting a mode in which power is supplied to a display.

According to an example embodiment of the present disclosure, an accessory device may include a first antenna configured to receive a first signal from an external device, a first switch configured to enable or disable an electrical connection between the first antenna and a controller. The controller may be configured to be electrically connected to the first antenna, and receive the first signal via the first antenna, perform a rectification operation of the first signal, and control the first switch so that the first switch is turned on or turned off based on a second signal received from the external device.

According to an example embodiment of the present disclosure, an accessory device may include a first cover and a second cover. The second cover may include first and second conductive patterns, a switch, and a controller thereon, the first and second conductive patterns each configured to perform a wireless communication with an external device, the switch configured to be electrically connected to the first conductive pattern, the switch is configured to be turned on or turned off such that the wireless communication between the external device and the first conductive pattern is enabled or disabled, and the controller configured to be electrically connected to the first conductive pattern, the second conductive pattern, and the switch, and configured to be turned on or turned off based on a second signal from the external device via the second conductive pattern.

According to an example embodiment of the present disclosure, an accessory device may include a first antenna configured to receive a first signal from an external device, a second antenna configured to receive a second signal including information for starting an authentication operation with the external device from the external device, a controller, a first switch, processing circuitry, a display device, and a second switch. The controller may be configured to rectify the first signal, generate an internal power from the rectified first signal, generate and transmit an authentication signal to the external device in response to the second signal, and be electrically connected to the first antenna and the second antenna, and transmit or receive data to and from the external device via the first antenna and the second antenna. The first switch may be configured to enable or disable a first electrical connection between the first antenna and the controller. The processing circuitry may be configured to receive the internal power from the controller. The display device may be configured to be driven by the processing circuitry. The second switch may be configured to enable or disable a second electrical connection between the controller and the processing circuitry. Further, the controller may be configured to determine a state of the first switch between a turn-on state and a turn-off state based on the second signal

However, aspects of the present inventive concepts are not restricted to the one set forth herein. The above and other aspects of the present inventive concepts will become more apparent to one of ordinary skill in the art to which the present inventive concepts pertains by referencing the detailed description of some example embodiments given below.

### BRIEF DESCRIPTION OF THE DRAWINGS

The above and other aspects and features of the present inventive concepts will become more apparent by describing in detail some example embodiments thereof with reference to the attached drawings, in which:

FIG. 1 illustrates a block diagram of an accessory device according to an example embodiment of the present inventive concepts;

FIG. 2 illustrates a block diagram of an electronic device and an accessory device according to an example embodiment of the present inventive concepts;

FIG. 3 is a flowchart for explaining an operation of a first switch according to an example embodiment of the present inventive concepts;

FIG. 4 illustrates a block diagram of the accessory device including a controller and a display device according to an example embodiment of the present inventive concepts;

FIG. 5 illustrates a block diagram of an accessory device including a second switch according to an example embodiment of the present inventive concepts;

FIG. 6 illustrates an example view illustrating the arrangement of a first conductive pattern and a second conductive pattern of the accessory device according to an example embodiment of the present inventive concepts;

FIG. 7 illustrates an example view illustrating the arrangement of the first conductive pattern, the second conductive pattern, and the controller of the accessory device according to an example embodiment of the present inventive concepts; and

FIG. 8 illustrates an example view illustrating the arrangement of the first conductive pattern, the second conductive pattern, the controller, a display driver integrated circuit, and a display of the accessory device according to an example embodiment of the present inventive concepts.

### DETAILED DESCRIPTION

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

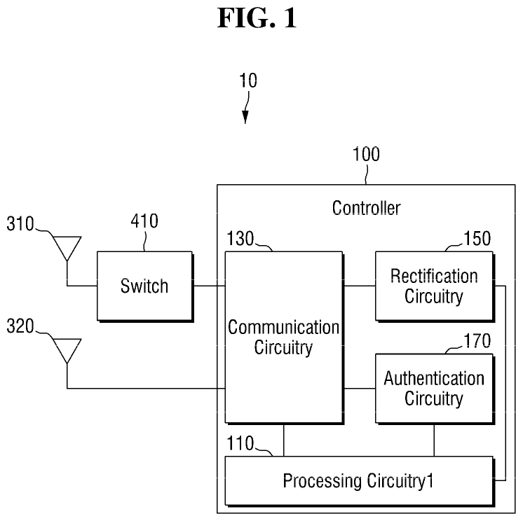

FIG. 1 illustrates a block diagram of an accessory device according to an example embodiment of the present inventive concepts.

Referring to FIG. 1, an accessory device 10 according to an example embodiment of the present inventive concepts may include a first antenna 310, a second antenna 320, a first switch 410 and a controller 100. The controller 100 may include first processing circuitry 110, first communication circuitry (or first communication module) 130, rectification circuitry (or rectification module) 150 and authentication circuitry (or authentication module) 170.

The various elements of the controller 100 may be various functional units that perform various corresponding operations and/or functions. However, the various elements of the controller 100 are not intended to be limited to the disclosed functional units. For example, the controller 100 may include one or more additional function units that perform some additional operations and/or functions corresponding thereto.

The first antenna 310 may receive a first signal from the outside. The first signal may be an RF signal having an RF Field coverage. The accessory device 10 may receive the first signal from the outside via the first antenna 310 and process the first signal based on the data included in the first signal, or may generate data to be output to the outside in response to the request included in the first signal.

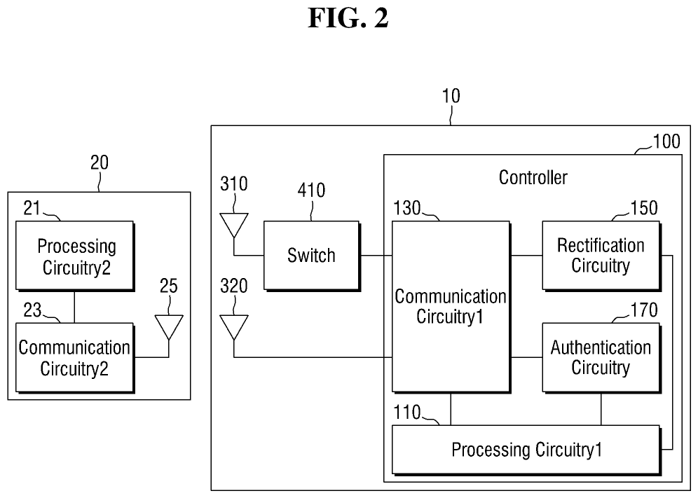

The second antenna 320 may receive a second signal from the outside. The accessory device 10 may receive the second signal from the outside via the second antenna 320, and may generate data to be output to the outside in response to the request included in the second signal based on the data included in the second signal. According to the example embodiment, the second signal may include information, which requests authentication of the accessory device 10. The authentication of the accessory device 10 may be an operation of determining whether the accessory device 10 is authentic. When the second signal includes information requesting authentication of the accessory device 10, the accessory device 10 may generate or extract authentication data or authentication signal including a predefined or desired public key or security key and may transmit the authentication data or the authentication signal to the external device from which the second signal is output. At this time, the authentication data or the authentication signal may be transmitted from the accessory device 10 to the outside via the second antenna 320. The second signal may be transmitted to the accessory device 10 via the second antenna 320 in the form of a predefined or desired protocol. The accessory device 10 may determine whether to turn on or turn off the first switch 410 by checking the protocol of the second signal received from the outside. According to some example embodiments, the second signal may include information on a target device in which communication with the external device is performed. Information on the target device may be represented by a predefined or desired protocol. The protocol form received by the accessory device 10 via the second antenna 320 will be described later with reference to FIG. 2.

The first switch 410 may enable or disable the electrical connection between the first antenna 310 and the first communication circuitry 130. As an example, in a first mode in which the first switch 410 operates in a turn-on state, the first antenna 310 and the first communication circuitry 130 may be electrically connected (enabled) to each other. That is, in the first mode, the accessory device 10 may communicate with the outside via the first antenna 310. As another example, in a second mode in which the first switch 410 operates in a turn-off state, the electrical connection between the first antenna 310 and the first communication circuitry 130 may be cut off (disabled). That is, in the second mode, the accessory device 10 may cut off communication with the outside via the first antenna 310.

The first processing circuitry 110 may control the operations of the first switch 410 and the controller 100. That is, the first processing circuitry 110 may determine the first mode in which the first switch 410 operates in the turn-on state or the second mode in which the first switch 410 operates in the turn-off state, and may control the first communication circuitry 130, the rectification circuitry 150 and the authentication circuitry 170 of the controller 100 so that an operation according to the determined operation mode is executed. Although FIG. 1 illustrates that the first switch 410 is electrically connected to the first communication circuitry 130, and the first processing circuitry 110 is connected to the first switch 410 via the first communication circuitry 130, example embodiments of the present inventive concepts are not limited thereto, but may be implemented so that the first processing circuitry 110 and the first switch 410 are directly connected to each other. Thus, the first processing circuitry 110 may determine the operating state (e.g., turn-on or turn-off) of the first switch 410 and may directly control the first switch 410 so that the determined operating state is applied.

The first communication circuitry 130 may communicate with the outside by receiving data from the outside or outputting data to the outside. For example, the first communication circuitry 130 may receive the first signal via the first antenna 310, and receive the data processed based on the first signal or data generated in response to the request included in the first signal, and output the data to the outside via the first antenna 310. In addition, the first communication circuitry 130 may receive the second signal via the second antenna 320, and output the data generated in response to the request included in the second signal to the outside via the second antenna 320.

According to some example embodiments, the first communication circuitry 130 may communicate with an external device, using wireless communication. The wireless communication may include, for example, at least one of a WiFi (wireless fidelity), a Bluetooth, a Bluetooth low power consumption (BLE), a zigbee, an NFC (near field communication), a magnetic secure transmission, a radio frequency (RF) or a body area network (BAN). According to some example embodiments, the wireless communication may include a GNSS. The GNSS may be, for example, a GPS (global positioning system), a Glonass (global navigation satellite system), a Beidou Navigation Satellite System (hereinafter “Beidou”) or a Galileo, the European global satellite-based navigation system.

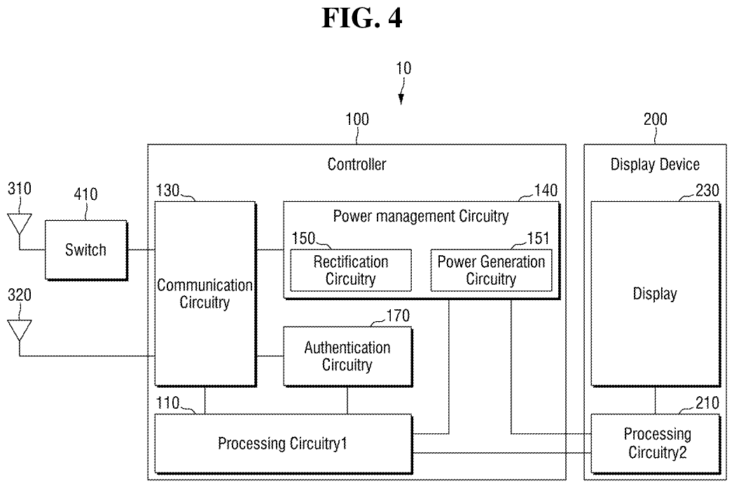

The rectification circuitry 150 may rectify the input AC type of wireless power to output a DC type of rectified wireless power. A person skilled in the art could be easily understand that the rectification circuitry 150 may be implemented as known rectification means, for example means such as a diode, and as long as it is capable of performing rectification, there is no limit. According to the example embodiment, the rectification circuitry 150 may receive the power from the first communication circuitry 130 and perform the rectification operation on the received power. For example, the rectification circuitry 150 may execute the rectification operation on the first signal received from the first antenna 310, generate an internal power based on the rectified first signal, and transfer the generated internal power to a display device (e.g., display device 200 of FIG. 4). A specific description of the generation and distribution of the internal power will be described later with reference to FIG. 4.

The authentication circuitry 170 may execute the authentication operation with the external device in response to the authentication request received from the outside. For example, when the second signal received via the second antenna 320 includes information requesting the authentication operation with the outside, the first processing circuitry 110 may control the authentication circuitry 170 to generate an authentication signal necessary for the authentication operation with the outside based on the received second signal, and the authentication circuitry 170 may generate an authentication signal in response to the second signal. The generated authentication signal may be transferred to the outside via the second antenna 320. At this time, the authentication signal may be generated, using a predetermined or desired public key or security key. That is, the accessory device 10 may include a predetermined or desired key that may determine whether the accessory device 10 is authentic, and the authentication circuitry 170 may generate and output the authentication signal to the outside via the second antenna 320 based on this, thereby executing the authentication operation.

Although not illustrated, the accessory device 10 according to the example embodiment of the present inventive concepts may further include an internal memory (not illustrated). The internal memory may function as a kind of buffer which may store a predefined or desired key necessary for the authentication operation of the accessory device 10, and temporarily stores the data received via the first antenna 310 or the second antenna 320, and transfers the data to a display device (display device 200 of FIG. 4), the first communication circuitry 130, the rectification circuitry 150, the authentication circuitry 170 or the first processing circuitry 110.

FIG. 2 illustrates a block diagram of an electronic device and an accessory device according to an example embodiment of the present inventive concepts. Hereinafter, a communication with the external device 20 is performed via the first antenna 310 and the second antenna 320, and enabling or disabling of a communication of the first antenna 310 using the first switch 410 will be described referring to FIG. 2.

The accessory device 10 according to an example embodiment of the present inventive concepts may communicate with the external device 20. According to the example embodiment, the external device 20 may include at least one of a smartphone, a tablet PC (personal computer), a mobile phone, a picture telephone, an e-book reader, a desktop PC, a laptop PC, a netbook computer, a workstation, a server, a PDA (personal digital assistant), a PMP (portable multimedia player), an MP3 player, a mobile medical device, a camera or a wearable device (e.g., smart glasses, a head-mounted-device (HMD), an electronic garment, an electronic bracelet, an electronic necklace, an electronic accessory, an electronic tattoo, a smart mirror, or a smart watch).

The spread and use of various electronic devices are rapidly increasing by virtue of the remarkable development of information communication technologies, semiconductor technologies, and the like. For example, recent electronic devices have been developed to communicate with each other, while being carried. For example, the electronic devices such as smart phones, personal computers and tablets provide several convenient functions to users via various applications. The electronic devices tend to transform into devices that may utilize various forms of information in addition to voice call functions through the provision of various functions. Recently, accessory devices connected to the electronic devices to interlock with electronic devices or perform some functions of the electronic devices have been developed and provided for use with the electronic devices. For example, the accessory device 10 may be various devices, such as a protective cover for protecting the electronic device, a dock capable of mounting the electronic device, a charging device capable of charging the electronic device or the like.

According to some example embodiments, the external device 20 may include a second processing circuitry 21 and a second communication circuitry (or second communication unit) 23, and may include an antenna module 25 connected to the second communication circuitry 23 to execute wireless communication with the outside. According to some example embodiments, the antenna module 25 of the external device 20 may include one antenna or a plurality of antennas, and the external device 20 may transmit and receive data via a radio communication with another electronic device through the antenna module 25.

The various circuitries included in the controller 100 and/or the various circuitries included in the external device 20 may be various functional units that are configured to perform various corresponding operations and/or functions. However, various circuitries included the controller 100 or the external device 20 are not intended to be limited to the disclosed circuitries. For example, the controller 100 or the external device 20 may include one or more additional circuitries that are configured to perform some additional operations and/or functions corresponding thereto.

The accessory device 10 according to the example embodiment of the present inventive concepts may perform the wireless communication with the external device 20. For example, the accessory device 10 may receive the signal, which is output from the external device via the antenna module 25, through the first antenna 310 or the second antenna 320, and may transmit the data processed based on the signal output from the external device or data generated in response to a request included in the signal output from the external device to the external device 20 via the first antenna 310 or the second antenna 320. According to some example embodiments, the wireless communication performed between the accessory device 10 and the external device 20 may include, for example, at least one of a WiFi (wireless fidelity), a Bluetooth, a Bluetooth low power consumption (BLE), a Zigbee, an NFC (near field communication), a magnetic secure transmission, a radio frequency (RF), or a body area network (BAN). According to some example embodiments, the wireless communication may include a GNSS. The GNSS may be, for example, a GPS (global positioning system), a Glonass (global navigation satellite system), a Beidou Navigation Satellite System (hereinafter “Beidou”), or a Galileo, the European global satellite-based navigation system.

According to some example embodiments, the accessory device 10 may receive a first signal, which is output from the external device 20 via the antenna module 25, through the first antenna 310. The first signal is transferred to the first communication circuitry 130, and the rectification operation of the first signal may be executed by the rectification circuitry 150 under the control of the first processing circuitry 110. Further, the first processing circuitry 110 may process the operation based on the first signal, and may control the first communication circuitry 130 to transmit the processed data to the external device 20 via the first antenna 310. In addition, the first processing circuitry 110 may generate data corresponding to the request included in the first signal, and may control the first communication circuitry 130 to transmit the generated data to the external device 20 via the first antenna 310.

According to some example embodiments, the first signal may include data of the output of the accessory device 10 corresponding to an event generated at the external device 20. For example, the first signal may include information on images that are output to the display (230 of FIG. 4), in accordance with incoming phone call events generated at the external device 20. As another example, the first signal may include information on images that are output to the display in accordance with message reception events generated at the external device 20.

According to some example embodiments, the accessory device 10 may receive the second signal, which is output from the external device 20 via the antenna module 25, through the second antenna 320. The second signal may be transferred to the first communication circuitry 130, and an operation corresponding to the request included in the second signal may be executed under the control of the first processing circuitry 110. For example, the second signal may include information on the authentication request of the accessory device 10, and the first processing circuitry 110 may control the authentication circuitry 170 to generate authentication data corresponding to the authentication request and may control the first communication circuitry 130 so that the generated authentication data is transmitted to the external device 20 via the second antenna 320.

According to some example embodiments, the first antenna 310 may be an antenna that receives a voltage through the NFC RF Field of the external device 20 to drive the accessory device 10. Further, the second antenna 320 may be an antenna that authenticates whether the accessory device 10 is authentic.

According to some example embodiments, the second processing circuitry 21 may generate a second signal including information on the target device in which communication with the external device 20 is executed, and may perform the control so that the second signal is transferred to the outside (for example, another electronic device or an accessory device 10) through the first communication circuitry 130 and the antenna module 25. Information on the target device may be represented by a predefined or desired protocol. For example, if the second signal is transferred through the first protocol, the second signal may include information requesting the authentication operation of the accessory device 10, and may include information in which the accessory device 10 is included in the target device. As another example, when the second signal is output from the external device 20 through the second protocol, the second signal may include information requesting an authentication operation for settlement with another electronic device, and in this case, the information in which the accessory device 10 is included in the target device may not be included in the second signal.

In a standby mode in which no data is transmitted and received for a predetermined or desired time via the first antenna 310 and the second antenna 320, the first processing circuitry 110 may control the first switch 410 so that the first switch 410 maintains the turn-off state. Therefore, in the standby mode, only the protocol corresponding to the second signal may be received via the second antenna 320. According to the example embodiment, when a second signal including the first protocol is received via the second antenna 320, the first processing circuitry 110 may control the first switch 410 to the turn-on state. The first protocol includes information in which the accessory device 10 is included in a target device on which communication with the external device 20 is performed, and may change the switch to the turn-on state to allow communication between the first antenna 310 and the external device 20. According to another example embodiment, when the second signal including the second protocol is received via the second antenna 320 in the standby mode, the first processor 110 may control the first switch 410 to maintain the turn-off state. The second protocol does not include the information in which the accessory device 10 is included in the target device, and thus the first processing circuitry 110 may control the first switch 410 to maintain the turn-off state so that the first antenna 310 does not receive the signal output from the external device 20.

According to an example embodiment of the present inventive concepts, the state (turn-on or turn-off) of the first switch 410 is determined based on the information included in the second signal, and when the accessory device 10 is not included in the target device, the first switch 410 may be maintained in the turn-off state. Thus, it is possible to reduce interference generated by the accessory device 10 in the course of communication between the external device 20 (e.g., a smartphone) and another electronic device (e.g., various portable medical measurement devices (a blood glucose meter, a heart rate monitor, a blood pressure measurer, or a body temperature measurer), an MRA (magnetic resonance angiography), an MRI (magnetic resonance imaging), a CT (computed tomography), a medical device such as photographing device and/or an ultrasonic device, a navigation device, a GNSS (global navigation satellite system), an EDR (event data recorder), a FDR (flight data recorder), a vehicle infotainment device, a marine electronic device such as a marine navigation device and/or a gyro compass, an avionics, a security device, a vehicle head unit, an industrial and domestic robot, an ATM (automatic teller's machine) of financial institutions, a POS (shop's point of sales), or internet of things (e.g. light bulbs, various sensors, an electricity or gas meter, a sprinkler device, a fire alarms, a thermostat, a street light, a toaster, an exercise machine, a hot water tank, a heater, or a boiler). Thus, it is possible to reduce the influence such as weakening or fluctuation of the RF field power due to the first antenna 310 (e.g., the RF/DC rectification antenna) of the accessory device 10 even if communication with the accessory device 10 is not desired, thereby making it possible to reduce the probability of the communication failure of the external device 20.

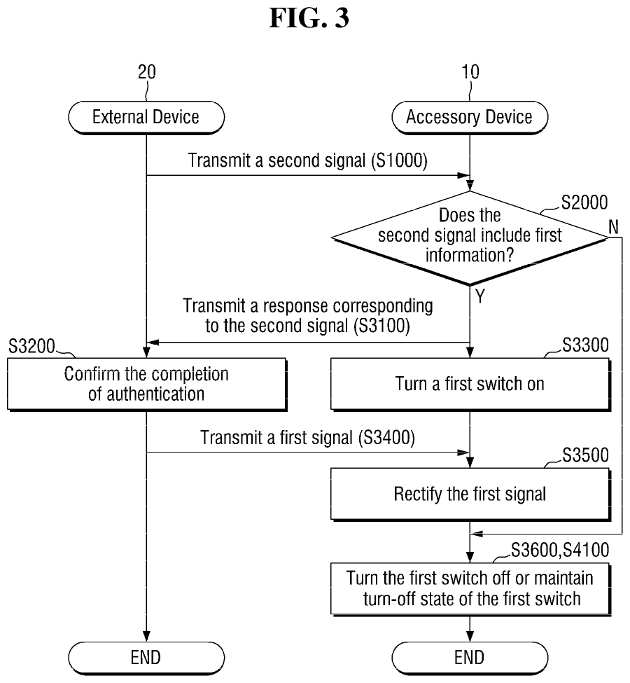

FIG. 3 is a flowchart for explaining the operation of the first switch according to an example embodiment of the present inventive concepts. Hereinafter, a process in which the state of the first switch 410 changes based on the second signal will be described with reference to FIGS. 2 and 3. For convenience of explanation, it is assumed that the first switch 410 is in a standby mode during which the first switch 410 is maintained in the turn-off state.

In operation S1000, the external device 20 may transmit the second signal to the accessory device 10. The second signal may include information that requests an authentication operation of the accessory device 10. Further, the second signal may include information on the target device, which performs communication with the external device 20. The accessory device 10 may receive the second signal via the second antenna 320, and the second signal received via the second antenna 320 may be transferred to the first communication circuitry 130.

In operation S2000, the accessory device 10 may determine whether the first information is included in the received second signal. According to some example embodiments, whether the second signal includes the first information may be determined by the first processing circuitry 110. According to some example embodiments, the first information may be information in which the accessory device 10 is included in the target device. Thus, the first processing circuitry 110 may determine whether to include information in which the accessory device 10 is included in the target device. According to some example embodiments, the first information may mean that the second signal is a signal including the first protocol. Thus, the first processing circuitry 110 may determine whether the second signal includes the first protocol including information requesting the authentication operation of the accessory device 10.

When it is determined that the second signal includes the first information, in operation S3100, the accessory device 10 may transmit a response corresponding to the request included in the second signal to the external device 20. According to some example embodiments, the second signal may include information requesting the authentication operation of the accessory device 10, and at this time, the response corresponding to the second signal may mean the authentication data including a predefined or desired public key or security key. Further, the authentication operation may be an operation of confirming whether the accessory device 10 is authentic. The first processing circuitry 110 may control the authentication circuitry 170 to generate authentication data as a response corresponding to the second signal, and may control the first communication circuitry 130 so that the generated authentication data is transmitted to the external device 20 via the second antenna 320.

In operation S3200, the external device 20 may complete the authentication operation of the accessory device 10 based on the authentication data transmitted from the accessory device 10. When the authentication data includes a predefined or desired public key or security key, it may be determined that the authentication operation of the accessory device 10 is successful, otherwise, it may be determined that the authentication operation of the accessory device 10 fails. Hereinafter, it is assumed that the authentication data includes a predefined or desired public key or security key, and therefore the authentication operation is successful.

In operation S3300, the first switch 410 of the accessory device 10 may be turned on. Because it is determined that the first information is included in the second signal in operation 3100, the accessory device 10 may be configured to receive or transfer the first signal from or to the external device 20 through the first antenna 310. Therefore, it is possible to turn the first switch 410 on for communication with the external device 20 through the first antenna 310. For example, the first processing circuitry 110 may directly control the first switch 410 so that the first switch 410 is changed to a turn-on state, or may control the first switch 410 to be turned on via the first communication circuitry 130.

For the sake of convenience of explanation, the explanation has been made in the order of operations S3200 and S3300, but this is an example, and after the operation according to operation S3300 is executed, the operation according to operation S3200 may be executed. Further, although it is illustrated that the operation of operation S3300 is executed after the execution of operation S3100, the order of the operations of operation S3100 and operation S3300 may be changed. That is, after the first switch 410 of the accessory device 10 is turned on, the response data or the response signal corresponding to the request included in the second signal may be transmitted to the external device 20 through the second antenna 320 of the accessory device 10.

In operation S3400, the external device 20 may transmit the first signal to the accessory device 10. According to some example embodiments, the accessory device 10 may receive the first signal via the first antenna 310, and may transmit the first signal to the first communication circuitry 130. Because the first signal is included in the second signal and the first switch 410 is turned on, communication via the first antenna 310 becomes possible, and the first signal output from the external device 20 may be received via the first antenna 310. According to some example embodiments, the first signal may include data of the output of the accessory device 10 corresponding to an event generated at the external device 20. For example, the first signal may include information on image that is output to the display (230 of FIG. 4) in accordance with the incoming phone call events generated at the external device 20. As another example, the first signal may include information on image that is output to the display in accordance with message reception events generated at the external device 20.

In operation S3500, the accessory device 10 may perform the rectification operation of the received first signal. According to some example embodiments, the first processing circuitry 110 may control the rectification circuitry 150 to perform the rectification operation of the first signal. The rectification circuitry 150 may output a first signal in the form of AC to a signal (or power) in the form of DC, and the rectified first signal may be transferred to the first processing circuitry 110 or may be transferred to the display device (200 of FIG. 4).

In operation S3600, the first switch 410 of the accessory device 10 may be turned off. According to some example embodiments, the first processing circuitry 110 may control the first switch 410 or the first communication circuitry 130 so that the first switch 410 is turned off when the data is not received from the external device 20 for a predetermined, preset, or desired time. That is, if there is no communication record with the external device 20 for a desired or predetermined time, the accessory device 10 may enter the standby mode. According to some example embodiments, the first processing circuitry 110 may control the first switch 410 or the first communication circuitry 130 so that the first switch 410 is turned off when all the operations based on the first signal are performed on the accessory device 10. For example, when the first signal includes a display output request of a specific event, the first processing circuitry 110 may control the first switch 410 o be turned off after executing the output operation of the requested event.

In operation S2000, if it is determined that the second signal does not include the first information, in operation S4100, the first processing circuitry 110 may control the first switch 410 to maintain the turn-off state. In other words, the standby mode of the accessory device 10 may be maintained.

FIG. 4 illustrates a block diagram of an accessory device including a controller and a display device according to an example embodiment of the present inventive concepts. For convenience of explanation, the description of the configuration of the accessory device 10 explained with reference to FIGS. 1 and 2 will not be provided.

Referring to FIG. 4, the controller 100 according to the example embodiment of the present inventive concepts may further include power management circuitry (or power management unit or module) 140, first communication circuitry 130, and first processing circuitry 110. The power consumption management circuitry 140 may include rectification circuitry (or rectification module) 150 and power generation circuitry (or power generation module) 151. Further, the accessory device 10 may further include a display device 200, and the display device 200 may include a second processing circuitry 210 and a display 230.

According to some example embodiments, the rectifier circuitry 150 may have the same configuration as the rectifier circuitry 150 described in FIGS. 1 and 2. That is, the rectification circuitry 150 may rectify the wireless power in the form of AC, which is input to output the rectified wireless power in the form of DC. The rectification circuitry 150 may be implemented as known rectification means, for example, means such as a diode.

According to some example embodiments, the power generation circuitry 151 may generate an internal power based on the signal that is output by the rectification circuitry 150. For example, the power level of the signal rectified by the rectification circuitry 150 is changed to generate an internal power to be transmitted to the second processing circuitry 210 of the display device 200, and the generated internal power may be transferred to the second processing circuitry 210. The second processing circuitry 210 may control the output of the display 230 based on the received internal power. According to another embodiment, the accessory device 10 may have a configuration in which the power generation circuitry 151 is omitted. That is, the power rectified by the rectification circuitry 150 is used as the internal power, which may be used as power for driving the display device 200.

According to some example embodiments, the display device 200 may include a second processing circuitry 210 and a display 230. The second processing circuitry 210 may control the display device 200. That is, the display device 200 may perform a control so that the event corresponding to the input data or the power is output to the display 230 based on the data or power that is input from the controller 100. According to the example embodiments, the display 230 may include at least one of a light emitting diode (LED) display, an organic light emitting diode (OLED) display, an electrophoretic display (EPD), a liquid crystal display (LCD), a microelectromechanical (MEMS) display or an E-ink (electronic ink).

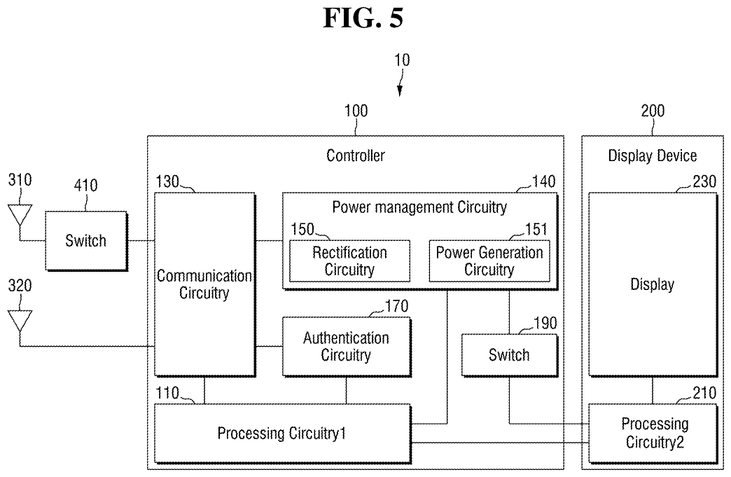

FIG. 5 illustrates a block diagram of an accessory device including a second switch according to an example embodiment of the present inventive concepts. For convenience of explanation, the description of the configuration of the accessory device 10 explained with reference to FIGS. 1, 2 and 4 will not be provided.

Referring to FIG. 5, the controller of the accessory device 10 according to the example embodiment of the present inventive concepts may further include a second switch 190. The second switch 190 may enable or disable the electrical connection between the power management circuitry 140 and the second processing circuitry 210. The first processing circuitry 110 may control the second switch 190 so that the internal power generated by the power management circuitry 140 is transferred or not transferred to the display device 200.

The various circuitries (e.g., the first communication circuitry 130, the power management circuitry 140, the authentication circuitry 170, the first processing circuitry 110, and the second switch 190) included in the controller 100 may be various functional units that are configured to perform various corresponding operations and/or functions. However, various circuitries of the controller 100 are not intended to be limited to the disclosed circuitries. For example, the controller 100 may include one or more additional circuitries that are configured to perform some additional operations and/or functions corresponding thereto.

According to some example embodiments, the first processing circuitry 110 may be control the second switch 190 so that the second switch 190 is changed to the turn-on state when the first signal output from the external device 20 is input to the first communication circuitry 130. According to some example embodiments, the first processing circuitry 110 may control the turn-on or turn-off state of the second switch 190 via the power management circuitry 140. According to some example embodiments, the first processing circuitry 110 may control the second switch 190 or the power management circuitry 140 so that the second switch 190 is changed to the turn-on state when the first switch 410 is changed to the turn-on state.

According to some example embodiments, when the first signal is received from the external device 20 via the first antenna 310, the first processing circuitry 110 may execute the rectification operation of the received first signal and may control the power management circuitry 140 to generate the internal power, and may control the second switch 190 so that the generated internal power is transferred to the display device 200. For example, the first processing circuitry 110 may transfer the internal power to the second processing circuitry 210 by turning the second switch 190 on. When the first signal is not received from the external device 20, the first processing circuitry 110 may reduce or minimize interference on the communication of the external device 20 by the antenna of the accessory device 10, by turning the second switch 190 off. Further, the first processing circuitry 110 may reduce or minimize the power consumption of the accessory device 10 and an external electronic device (e.g., the external device 20 of FIG. 2) by adjusting the mode in which the power is supplied to the display device 200.

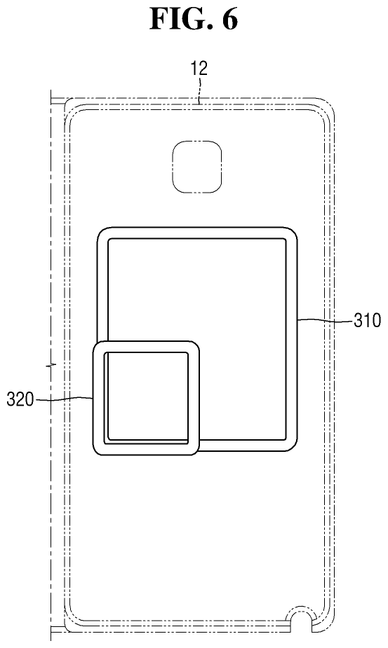

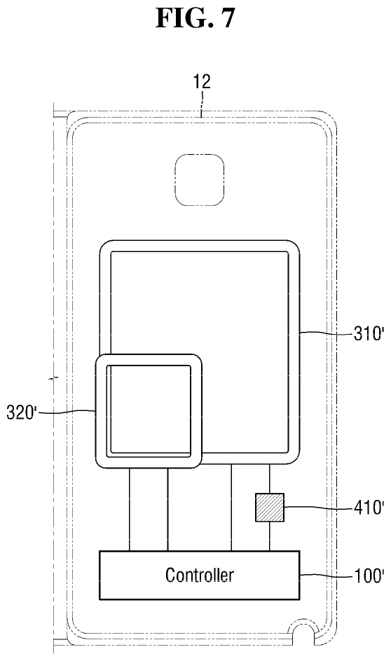

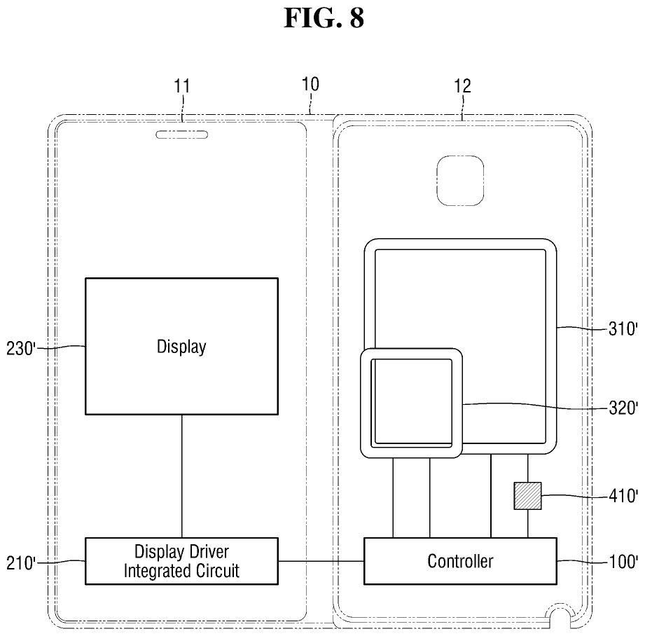

FIG. 6 is an example view illustrating the arrangement of the first conductive pattern and the second conductive pattern of the accessory device according to an example embodiment of the present inventive concepts, FIG. 7 is an example view illustrating an arrangement of the first conductive pattern, the second conductive pattern and the controller of the accessory device according to the example embodiment of the present inventive concepts, and FIG. 8 is an example view illustrating the arrangement of the first conductive pattern, the second conductive pattern, the controller, the display driver integrated circuit and the display of the accessory device according to the example embodiment of the present inventive concepts.

The accessory device 10 according to an example embodiment of the present inventive concepts may include a first cover 11, and a second cover 12. The first cover 11 and the second cover 12 may be disposed side by side or may face (or may be opposite to) each other when folded. According to some example embodiments, the first cover 11 may be a cover that comes into contact with a front surface of the accessory device 10 on which a display of an external electronic device (e.g., a smart phone) is located, and the second cover 12 may be a cover that is brought into contact with a back surface of the external electronic device.

Referring to FIG. 6, the accessory device 10 according to an example embodiment of the present inventive concepts may include a first conductive pattern 310′ and a second conductive pattern 320′ disposed on the second cover 12 to execute a wireless communication with an external device. According to some example embodiments, each of the first conductive pattern 310′ and the second conductive pattern 320′ may have the same configurations and functions as those of the first antenna 310 and the second antenna 320 of FIG. 1, respectively. As illustrated, according to some example embodiments, the first conductive pattern 310′ may be configured to have a larger area than the second conductive pattern 320′. According to some example embodiments, the second conductive pattern 320′ may transmit and receive signals, which are used for an authentication operation between the accessory device 10 and the external device, to and from the external device.

Referring to FIG. 7, the accessory device 10 according to an example embodiment of the present inventive concepts may include a controller 100, which is disposed on the second cover 12 and electrically connected to the first conductive pattern 310′ and the second conductive pattern 320′. The controller 100′ may have the same configuration and function as the controller 100 of FIG. 1. For example, the controller 100′ may determine the turn-on or turn-off state of the first switch 410′ based on the second signal received from the external device via the second conductive pattern 320′. Further, the accessory device 10 according to the example embodiment of the present inventive concepts may further include a first switch 410′ disposed on the second cover 12 and electrically connected to the first conductive pattern 310. The first switch 410′ may be turned on to perform a wireless communication between the external device and the first conductive pattern 310′, and may be turned off to cut off the wireless communication between the external device and the first conductive pattern.

Referring to FIG. 8, the accessory device 10 according to the example embodiment of the present inventive concepts may further include a display driver integrated circuit 210′, which is disposed on the first cover 11 and electrically connected to the controller 100′ for receiving the power supplied by the controller 100′, and a display 230′ driven by the display driver integrated circuit 210′. According to some example embodiments, the display driver integrated circuit 210′ and the display 230′ may have the same configurations and function as those of the second processing circuitry 210 and the display 230 of FIG. 4, respectively.

According to some example embodiments, the controller 100′ may rectify the first signal received from the external device via the first conductive pattern 310′ and extract the internal power from the rectified first signal to supply the internal power to the display driver integrated circuit 210′.

According to some example embodiments, the display 230′ may include at least one of a light emitting diode (LED) display, an organic light emitting diode (OLED) display, an electrophoretic display (EPD), a liquid crystal display (LCD), a microelectromechanical (MEMS) display, or an E-ink (electronic ink).

The controllers and various circuitries included in the example embodiments described herein may include processing circuitry such as hardware including logic circuits, a hardware/software combination such as a processor executing software, or a combination thereof. For example, the processing circuitry more specifically may include, but is not limited to, a Central Processing Unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

In concluding the detailed description, those skilled in the art will appreciate that many variations and modifications may be made to the disclosed example embodiments without substantially departing from the principles of the present inventive concepts. Therefore, the disclosed example embodiments of the inventive concepts are used in a generic and descriptive sense only and not for purposes of limitation.

1. An accessory device comprising:
a first antenna configured to receive a first signal from an external device;
a first switch configured to enable or disable an electrical connection between the first antenna and a controller and disposed between the first antenna and the controller; and
the controller configured to,
be electrically connected to the first antenna, and receive the first signal via the first antenna,
perform a rectification operation of the first signal, and
control the first switch so that the first switch is turned on or turned off based on a second signal received from the external device.

2. The accessory device of claim 1, further comprising:
a second antenna configured to receive the second signal from the external device, the second signal including first information on a target device in which a communication with the external device is executed.

3. The accessory device of claim 2, wherein
the controller is configured to control the first switch to a turn-on state such that the first antenna and the communication module are electrically connected, in response to the second signal including second information that the accessory device is included in the target device, and
the controller is configured to maintain the first switch in a turn-off state such that the first antenna and the communication circuit are electrically disconnected, in response to the second signal not including the second information.

4. The accessory device of claim 2, wherein the controller is further configured to,
execute an authentication operation with the external device,
generate an authentication signal in response to the second signal including second information on a start of the authentication operation with the external device, and
transmit the authentication signal to the external device via the second antenna.

5. The accessory device of claim 4, wherein, the controller is further configured to generate the authentication signal in response to the second signal including third information that the accessory device is included in the target device.

6. The accessory device of claim 1, wherein the controller is further configured to,
generate internal power based on the first signal; and
be electrically connected to a display device by supplying the internal power thereto.

7. The accessory device of claim 6, wherein the controller is configured to generate the internal power based on the first signal that has been rectified by the rectification operation.

8. The accessory device of claim 6, wherein the controller is configured to form an electrical path between the first antenna and the display device upon receiving the first signal from the first antenna, and transfer data included in the first signal to the display device.

9. The accessory device of claim 8, wherein the display device comprises processing circuitry that is configured to be electrically connected to the controller and drive the display device.

10. The accessory device of claim 9, wherein the controller is configured to,
convert a first voltage of a first level generated from the first antenna into a second voltage of a second level in the rectification operation, and
provide the second voltage to the processing circuitry.

11. An accessory device comprising:
a first cover; and
a second cover, the second cover including first and second conductive patterns, a switch, and a controller thereon, the first and second conductive patterns each configured to perform a wireless communication with an external device, the switch configured to be electrically connected to the first conductive pattern, the switch configured to be turned on or turned off such that the wireless communication between the external device and the first conductive pattern is enabled or disabled, the switch disposed between the first conductive pattern and the controller; and
the controller configured to be electrically connected to the first conductive pattern, the second conductive pattern and the switch, and configured to determine a state of the switch between a turn-on state and a turn-off state based on a second signal from the external device via the second conductive pattern.

12. The accessory device of claim 11, wherein the first conductive pattern is configured to have an area larger than the second conductive pattern.

13. The accessory device of claim 11, wherein the second conductive pattern is configured to transmit or receive a signal used for an authentication operation between the accessory device and the external device.

14. The accessory device of claim 11, further comprising:
a display driver integrated circuit being on the first cover and configured to be electrically connected to the controller on the second cover and supplied with power by the controller; and
a display configured to be driven by the display driver integrated circuit.

15. The accessory device of claim 14, wherein the controller is configured to rectify a first signal from the external device via the first conductive pattern, extract internal power from the rectified first signal, and supply the internal power to the display driver integrated circuit.

16. The accessory device of claim 14, wherein the display comprises at least one of a light emitting diode (LED) display, an organic light emitting diode (OLED) display, an electrophoretic display (EPD), a liquid crystal display (LCD), a microelectromechanical (MEMS) display, or an electronic ink (E-ink).

17. An accessory device comprising:
a first antenna configured to receive a first signal from an external device;
a second antenna configured to receive a second signal including information for starting an authentication operation with the external device from the external device;
a controller configured to,
rectify the first signal,
generate an internal power from the rectified first signal,
generate and transmit an authentication signal to the external device in response to the second signal, and
be electrically connected to the first antenna and the second antenna, and transmit or receive data to and from the external device via the first antenna and the second antenna;
a first switch configured to enable or disable a first electrical connection between the first antenna and the controller;
processing circuitry configured to receive the internal power from the controller;
a display configured to be driven by the processing circuitry; and
a second switch configured to enable or disable a second electrical connection between the controller and the processing circuitry,
wherein the controller is configured to determine a state of the first switch between a turn-on state and a turn-off state based on the second signal.

18. The accessory device of claim 17, wherein the second signal includes information on a target device with which the external device is configured to communicate, and
the controller configured to control the first switch to
change the first switch to the turn-on state in response to the second signal including a first information that the accessory device is included in the target device includes, and
maintain the first switch in the turn-off state in response to the second signal not including the first information.

19. The accessory device of claim 17, wherein the controller is configured to control the second switch so that the second switch is changed to the turn-on state, in response the controller receiving the first signal from the external device.

20. The accessory device of claim 17, wherein each of the first antenna and the second antenna executes a data transmission and reception operation with the external device using a near field communication (NFC) protocol.
